(19) United States
(12) Patent Application Publication
(10) Pub. No.: US 2014/0249887 A1
(43) Pub. Date: Sep. 4, 2014

(54) SYSTEM FOR MONITORING CUSTOMERS WITHIN RETAIL PREMISES

(71) Applicant: RapidBlue Solutions Oy, (US)

(72) Inventors: Sampo Parkkinen, Helsinki (FI); Gavin Weigh, Helsinki (FI)

(73) Assignee: RAPIDBLUE SOLUTIONS OY, Helsinki (FI)

(21) Appl. No.: 13/782,423

(22) Filed: Mar. 1, 2013

(51) Int. Cl. G06Q 30/02

(52) U.S. Cl. CPC G06Q 30/0201; G06Q 30/0202
USPC 705/7.31; 705/7.29

(57) ABSTRACT

The present disclosure provides a monitoring system for monitoring customers within a retailing premises. The monitoring system includes a data processing arrangement, and a wireless communication network coupled in communication with the data processing arrangement. The customers are provided with corresponding wireless devices. Each wireless device is identified by an associated identification code (ID). The wireless devices communicate with the wireless communication network, and thereby enable the data processing arrangement to monitor and record routes of the customers using these wireless devices within the retailing premises.

The present disclosure generally relates to monitoring systems, and more specifically, to methods and systems for monitoring customers within retailing premises. Further, aspects of the disclosure are also directed to software products recorded on machine-readable data storage media, wherein such software products are executable upon computing hardware, to implement the methods of the disclosure.

### BACKGROUND

Today, customers have an option to choose from various offline and online purchase channels, such as brick-and-mortar venues, Internet and mobile networks. Online purchase channels are being increasingly adopted by the customers, while offline retailers are struggling to cope with the growth rates of the online purchase channels.

Moreover, the online purchase channels are able to understand not only purchases made by their customers, but also actions taken by their customers that resulted in those purchases. Traditional offline retails mostly fail to do so, and are at a disadvantage here. In order to survive and prosper in this competitive era, offline retails must employ tools to understand their customers.

Conventional techniques use retail information, such as footfall figures, to measure retail performance of retailing premises. Footfall figures represent the number of customers who visited a particular retailing premises during a particular period. However, it has been found that footfall figures do not provide accurate information about the retail performance.

Therefore, there exists a need for a method and a system for monitoring customers within retailing premises, which enables owners of the retailing premises to understand their customers in a similar manner as pertains to the online purchase channels.

### SUMMARY

The present disclosure provides a method and a system for monitoring customers within retailing premises.

In one aspect, embodiments of the present disclosure provide a monitoring system for monitoring one or more customers within a retailing premises. The monitoring system includes a data processing arrangement, and a wireless communication network coupled in communication with the data processing arrangement. The customers use their corresponding wireless devices, which are provided with associated identification codes (ID).

The wireless devices are operable to communicate with the wireless communication network for enabling the data processing arrangement to monitor and record one or more routes of the wireless devices within the retailing premises. The wireless devices may, for example, be implemented as smart telephones provided with a hardware and/or software application that enables the wireless devices to communicate via the wireless communication network with the data processing arrangement.

The data processing arrangement employs the wireless communication network to determine spatial data pertaining to the wireless devices. The spatial data pertaining to the wireless devices may, for example, include their associated IDs, spatial positions of the wireless devices, and associated time stamps. The data processing arrangement may determine the spatial positions of the wireless devices, for example, by way of triangulation.

The data processing arrangement analyzes the spatial data pertaining to the wireless devices, to record the routes of the wireless devices as a function of time. The data processing arrangement then analyzes the routes of the wireless devices, to determine one or more predefined position parameters, which includes at least one of: customer volumes, customer dwell-times, Gross Shopping Hours (GSH), and visiting frequencies.

Optionally, the monitoring system includes one or more position databases for storing data pertaining to the routes of the wireless devices and/or the predefined position parameters.

In accordance with an embodiment of the present disclosure, the predefined position parameters act as an indicator of retail performance and sales. The data processing arrangement analyzes the predefined position parameters, to make predictions on sales in real time. For example, the GSH can be used to approximately predict sales in real time.

Further, the monitoring system also includes one or more commercial databases for storing commercial data pertaining to transactions occurring within the retailing premises. The commercial data is indicative of the spatial positions of the wireless devices. The commercial data includes at least one of: shop identification, boutique identification, marketing campaign identification, discount campaign identification, and associated time stamps.

The data processing arrangement analyzes the commercial data and the routes, to determine one or more predefined commercial parameters, which include at least one of: sales volumes, and increase in sales volume associated with one or more marketing campaigns being provided at the retailing premises. The sales volume may, for example, be determined as a function of the routes taken by the wireless devices as a function of time.

Optionally, the data processing arrangement stores data pertaining to the predefined commercial parameters in the commercial databases.

In accordance with an embodiment of the present disclosure, the data processing arrangement analyzes the predefined position parameters and/or the predefined commercial parameters, to identify fluctuations in at least one of: sales volume, GSH, customer volumes, customer dwell-times, and visiting frequencies. Based on these fluctuations, the data processing arrangement may determine the rents and/or rates for a plurality of zones within the retailing premises.

Based on the fluctuations, the data processing arrangement also determines trends and patterns in the behavior of the customers using the wireless devices. The data processing arrangement then creates a mathematical model describing the movement of the wireless devices within the retailing premises, and applies a learning system on the mathematical model to generate a function describing trends occurring in the retailing premises.

Subsequently, the data processing arrangement makes a prediction of future sales and/or GSH within the retailing premises in relation to the marketing campaigns.

In accordance with an embodiment of the present disclosure, the data processing arrangement is operable to apply neural network algorithms and/or fuzzy logic for executing the analyses. In accordance with an embodiment of the present disclosure, the data processing arrangement executes the analyses in real time.

In accordance with an additional embodiment of the present disclosure, the data processing arrangement determines theft of items at the retailing premises as a function of the routes taken by the wireless devices as a function of time. For this purpose, the monitoring system may include one or more cameras installed at suitable positions within the retailing premises. The data processing arrangement may then employ the cameras to track the customers within the retailing premises, for use in the analysis of theft. The analysis of theft enables, for example, the retailing premises to be rearranged for reducing a tendency for theft to occur, for example deploying additional monitoring cameras in regions of the retailing premises where thefts are more frequently found to occur.

In another aspect, embodiments of the present disclosure provide a method of using the monitoring system for monitoring the customers within the retailing premises.

Embodiments of the present disclosure substantially eliminates the aforementioned problems faced by offline retails, and enable owners of offline retailing premises to understand fluctuations in sales in real time by using GSH as an indicator, to predict impact of various campaigns and other efforts without a need for complicated integration of real-time commercial transactions, or to achieve higher return on investment (RGI) by suggesting changes in future marketing campaigns.

Additional aspects, advantages, features and objects of the present disclosure would be made apparent from the drawings and the detailed description of the illustrative embodiments construed in conjunction with the appended claims that follow.

It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of an example retailing premises that is suitable for practicing various implementations of the present disclosure.

FIG. 2 is an illustration of a monitoring system for monitoring one or more customers within the retailing premises, in accordance with the present disclosure.

FIG. 3 is an illustration of various components in one exemplary implementation of a data processing arrangement, in accordance with the present disclosure.

FIG. 4 is an illustration of steps of a method of using the monitoring system for monitoring the customers within the retailing premises, in accordance with the present disclosure.

FIG. 5A is an illustration of steps of a detailed method of using the monitoring system for monitoring the customers within the retailing premises, in accordance with the present disclosure, through the step of determining the predefined commercial parameters as a function of time.

### DETAILED DESCRIPTION OF ILLUSTRATIVE EMBODIMENTS

The following detailed description illustrates embodiments of the disclosure and ways in which it can be implemented. Although the best mode of carrying out the invention has been disclosed, those in the art would recognize that other embodiments for carrying out or practicing the invention are also possible.

The present disclosure provides a monitoring system for monitoring customers within a retailing premises. The monitoring system includes a data processing arrangement, and a wireless communication network coupled in communication with the data processing arrangement. The customers are provided with corresponding wireless devices. Each wireless device is identified by an associated identification code (ID). The wireless devices communicate with the wireless communication network, and thereby enable the data processing arrangement to monitor and record routes of the customers using these wireless devices within the retailing premises.

The wireless devices may be implemented as smart telephones provided with a software application that enables the wireless devices to communicate via the wireless communication network with the data processing arrangement. Typical examples of the wireless devices include, although are not limited to, smart phones, Mobile Internet Devices (MID), wireless-enabled tablet computers, Ultra-Mobile Personal Computers (UMPC), tablets, tablet computers, Personal Digital Assistants (PDA), web pads, and cellular phones.

The wireless communication network is employed to determine spatial data pertaining to the wireless devices, for example, by way of triangulation. Subsequently, the data processing arrangement records the routes of the wireless devices as a function of time.

The routes of the wireless devices provide information about behavior of the customers using these wireless devices within the retailing premises. For example, these routes provide information about at least one of: the number of customers traversing the retailing premises, one or more dwell times of the customers within the retailing premises, Gross Shopping Hours (GSH) spent by the customers within the retailing premises, and the frequency with which the customers visit the retailing premises.

The monitoring system also includes one or more databases for storing data pertaining to the routes of the wireless devices. The data processing arrangement analyzes data stored in the databases for determining sales at the retailing premises as a function of routes taken by the customers using the wireless devices as a function of time. In accordance with an embodiment of the present disclosure, the data processing arrangement determines sales at the retailing premises in real time. Based on the analysis, the data processing arrangement may also determine the rents and/or rates for various zones within the retailing premises, for example where the retailing premises corresponds to a shopping mall including a configuration of boutiques selling mutually different types of products or services.

In accordance with an additional embodiment of the present disclosure, the data processing arrangement analyzes data stored in the databases for determining theft of items at the retailing premises as a function of routes taken by the wireless devices as a function of time.

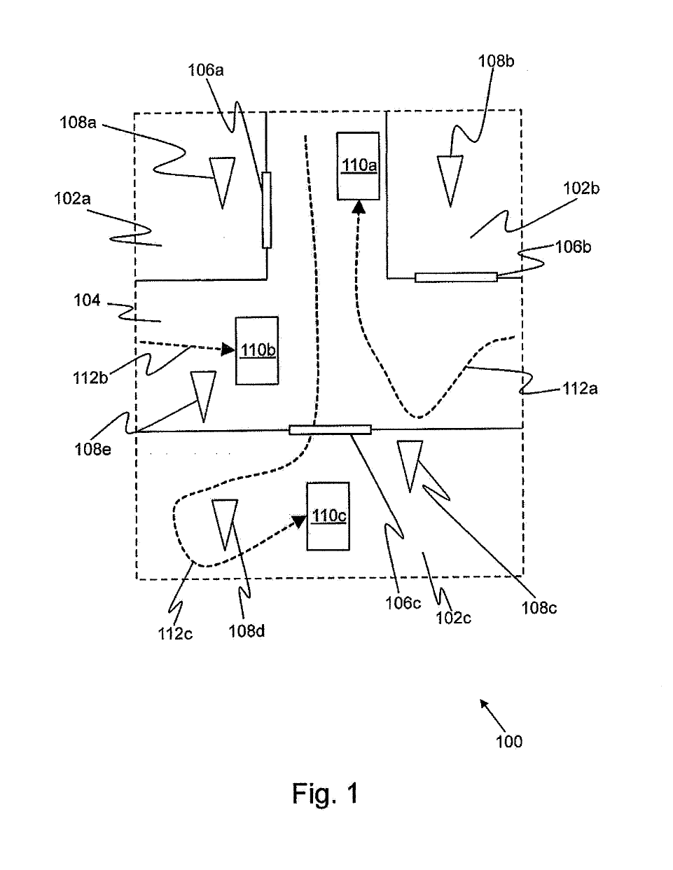

Referring now to the drawings, particularly by their reference numbers, FIG. 1 is an illustration of an example retailing premises 100 that is suitable for practicing various implementations of the present disclosure. The retailing premises 100 is optionally partitioned into a plurality of zones. For discussion purposes, these zones are depicted as shops 102a, 102b and 102e (hereinafter collectively referred to as shops 102) along a hallway 104 in FIG. 1. Customers can enter and/or exit the shops 102 via entrances and/or exit doors, depicted as doors 106a, 106b and 106e in FIG. 1 (hereinafter collectively referred to as doors 106).

The retailing premises 100 is equipped with a plurality of wireless apparatus, depicted as wireless apparatus 108a, 108b, 108e, 108d and 108e in FIG. 1 (hereinafter collectively referred to as wireless apparatus 108). The wireless apparatus 108 may, for example, be wireless routers for Wi-Fi communication, or Bluetooth base stations; “BlueTooth” is a registered trademark. In addition, the doors 106 are equipped with additional wireless apparatus (not shown in FIG. 1), for detecting when customers enter and/or exit the retailing premises 100.

With reference to FIG. 1, customers A, B and C carry corresponding wireless devices 110a, 110b and 110e (hereinafter collectively referred to as wireless devices 110), respectively. Typical examples of the wireless devices 110 include, although are not limited to, smart phones, MIDs, wireless-enabled tablet computers, UMPCs, tablets, tablet computers, PDAs, web pads, and cellular phones.

Customers A, B and C move in and around the shops 102 and the hallway 104 within the retailing premises 100, while their corresponding wireless devices 110 communicate with the wireless apparatus 108. The wireless devices 110 may, for example, be provided with suitable hardware and/or software applications that support wireless communication, such as Wi-Fi and Bluetooth technology; “BlueTooth” is a registered trademark. The wireless devices 110 may, for example, transmit their identification codes (ID) to the wireless apparatus 108 on their own. Alternatively, the wireless apparatus 108 may send a request for identification to the wireless devices 110, which may then transmit their ID to the wireless apparatus 108. The ID may, for example, be Media Access Control (MAC) address, Terminal Identifier (TID), Service Set Identifier (SSID), or other identification pertaining to the wireless devices 110.

Subsequently, the wireless apparatus 108 transmit data pertaining to the wireless devices 110 to a data processing arrangement (not shown in FIG. 1). The data processing arrangement then determines spatial data pertaining to the wireless devices 110, for example, by way of triangulation. For example, the spatial data pertaining to the wireless device 110a may include an ID associated with the wireless device 110a, one or more spatial positions of the wireless device 110a, and associated time stamps.

Alternatively, the wireless devices 110 may be configured to provide their spatial positions along with their ID to the wireless apparatus 108 on their own. For this purpose, the wireless devices 110 may be provided with one or more maps of the retailing premises 100.

The data processing arrangement analyzes the spatial data pertaining to the wireless devices 110, to record routes 112a, 112b and 112c taken by the customers A, Band C using the wireless devices 110a, 110b and 110c, respectively. The routes 112a, 112b and 112c are hereinafter collectively referred to as routes 112. In accordance with an embodiment of the present disclosure, the routes 112 are recorded as a function of time.

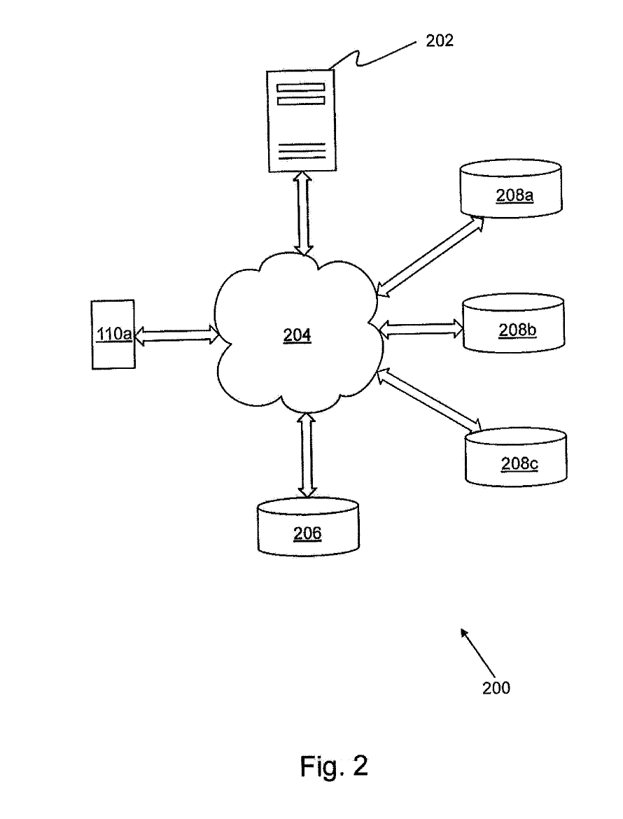

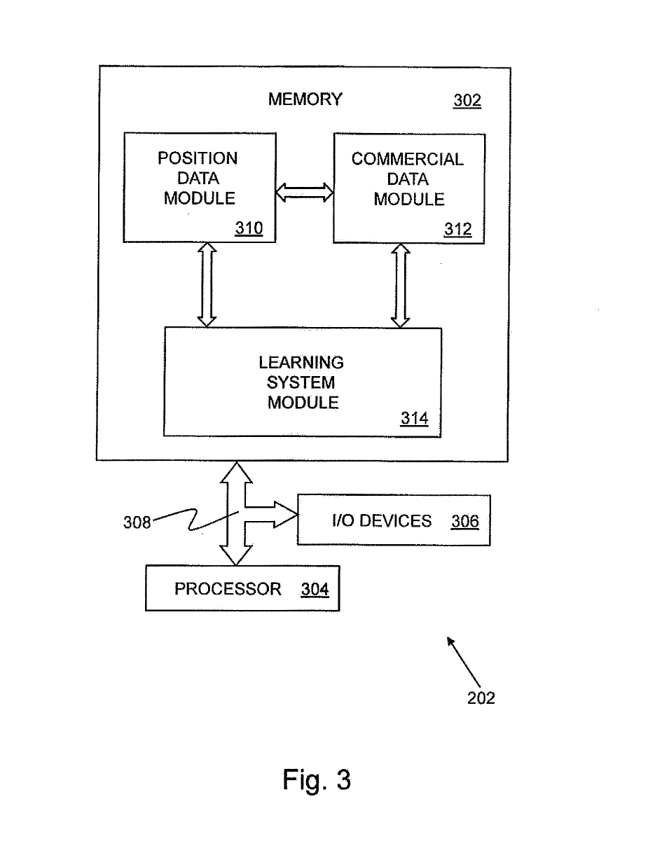

The data processing arrangement may then analyze the routes 112 taken by the customers A, Band C, to determine sales at the shops 102 and/or the retailing premises 100 as a function of the routes 112. In accordance with an embodiment of the present disclosure, the data processing arrangement determines sales at the shops 102 and/or the retailing premises 100 in real time. Details regarding the same have been provided with reference to FIGS. 2 and 3.

In another example, the data processing arrangement may determine theft of items at the shops 102 and/or the retailing premises 100 as a function of the routes 112. Such theft is beneficially identifiable from discrepancies between records of purchased stock for the retailing premises 100, sales occurring at checkouts of the retailing premises 100 and periodic stock checks; as the records of purchased stock are time dependent, similarly sales at checkouts (Point-Of-Sale) and stock checks, approximate times of such theft can then be determined and identities ID of users, namely customers, in a spatial vicinity from where the thefts occurred determined. This analysis may identify a group of identities ID which may have been responsible for the thefts; by performing a frequency analysis of identities ID over a period of time against thefts, particular ID's having a high frequency of associated with thefts can be pursued further to reprimand delinquent and errant users of the retailing premises 100. Beneficially, employees as the retailing premises 100 are also provided with wireless devices 110, because many thefts in practice are found to be perpetrated by employees.

It should be noted here that the retailing premises 100 is not limited to a specific number of shops 102, doors 106, wireless apparatus 108 and wireless devices 110. FIG. 1 is merely an example, which should not unduly limit the scope of the claims herein. One of ordinary skill in the art would recognize many variations, alternatives, and modifications of embodiments herein. For example, retailing premises 100 can be implemented as an “open plan” environment wherein user are able to move from boutique to another without being aware of boundaries between the boutiques, namely having an impression of a continuum of retailing space.

FIG. 2 illustrates a monitoring system 200 for monitoring customers within the retailing premises 100, in accordance with the present disclosure. The monitoring system 200 includes a data processing arrangement 202, and a wireless communication network 204 coupled in communication with the data processing arrangement 202. The wireless communication network 204 can be a collection of individual networks, interconnected with each other and functioning as a single large network. Typical examples of such individual networks include, although are not limited to, Wireless Local Area Networks (WLAN), Personal-Area Networks (PAN), and piconets.

The wireless communication network 204 is partly implemented in the form of the wireless apparatus 108, which communicate with the wireless devices 110 as described in FIG. 1. The data processing arrangement 202 employs the wireless communication network 204 to determine spatial data pertaining to the wireless devices 110. For example, the spatial data pertaining to the wireless device 110a may include an ID associated with the wireless device 110a, one or more spatial positions of the wireless device 110a, and associated time stamps.

The data processing arrangement 202 may determine spatial positions of the wireless devices 110, for example, by way of triangulation. Alternatively, the data processing arrangement 202 may determine a spatial position of a particular wireless device as the location of a wireless apparatus in proximity to that wireless device.

In yet another alternative, the wireless devices 110 may be configured to provide their spatial positions along with their ID to the wireless apparatus 108 on their own. For this purpose, the wireless devices 110 may be provided with one or more maps of the retailing premises 100.

The data processing arrangement 202 analyzes the spatial data pertaining to the wireless devices 110, to record the routes 112 of the wireless devices 110 within the retailing premises 100. In accordance with an embodiment of the present disclosure, the routes 112 are recorded as a function of time.

The monitoring system 200 includes one or more position databases, depicted as a position database 206 in FIG. 2. The position database 206 stores data pertaining to the routes 112 of the wireless devices 110 within the retailing premises 100. The data processing arrangement 202 is operable to communicate with position database 206 either in real time or periodically.

The data processing arrangement 202 analyzes the routes 112 of the wireless devices 110, to determine one or more predefined position parameters. The predefined position parameters include at least one of:
(a) the number of the wireless devices 110 having routes traversing the shops 102 and/or the hallway 104 (hereinafter referred to as customer volumes),
(b) one or more dwell times of the wireless devices 110 within the shops 102 and/or the hallway 104 (hereinafter referred to as customer dwell-times),
(c) Gross Shopping Hours (GSH) spent by the customers using the wireless devices 110 within the shops 102 and/or the hallway 104, and
(d) a visiting frequency of the wireless devices 110 within the shops 102 and/or the hallway 104 over a period (hereinafter referred to as visiting frequencies).

‘Customer volumes’ provide information about the number of customers that traversed a particular zone within the retailing premises 100, while ‘visiting frequencies’ provide information about the frequency with which a particular customer or a group of customers visited a particular zone within the retailing premises 100.

‘Customer dwell-times’ provide information about the time duration for which the customers dwelled within a particular zone within the retailing premises 100.

‘Gross Shopping Hours’ combines customer volumes and customer dwell-times. The GSH of a particular zone within the retailing premises 100 may, for example, be calculated as a product of customer volumes and average customer dwell-times pertaining to that particular zone. Alternatively, the GSH may be calculated as a total of customer dwell-times of all the customers traversing that particular zone.

The predefined position parameters may be either system-defined or user-defined. The predefined position parameters may be determined for each shop separately, for a group of shops located in proximity to each other, or for the retailing premises 100 as a whole. The predefined position parameters may be determined periodically, or for a predefined period. The predefined position parameters may be determined for a single customer or a group of customers. The predefined position parameters may also be determined for certain demographics based on gender, income level, shopping history, and so on.

In accordance with an embodiment of the present disclosure, the predefined position parameters act as an indicator of retail performance and sales. The data processing arrangement 202 analyzes the predefined position parameters, to make predictions on sales in real time. For example, the GSH can be used to approximately predict sales volume in real time.

In addition, the data processing arrangement 202 stores data pertaining to the predefined position parameters in the position database 206. Such data may, for example, be stored as a function of time.

Further, the monitoring system 200 also includes commercial databases 208a, 208b and 208e for storing commercial data pertaining to transactions occurring within shops 102a, 102b and 102e, respectively. Commercial databases 208a, 208b and 208e are hereinafter referred to as commercial databases 208. The commercial data is indicative of the spatial positions of the wireless devices 110, such as shops in which commercial transactions have been performed by the customers using the wireless devices 110, and/or shops in which marketing campaigns have been conducted. The commercial data includes at least one of: shop identification, boutique identification, marketing campaign identification, discount campaign identification, and associated time stamps.

The data processing arrangement 202 is operable to communicate with commercial databases 208 either in real time or periodically. The data processing arrangement 202 analyzes the commercial data and the routes 112, to determine one or more predefined commercial parameters. The predefined commercial parameters include at least one of:
(a) sales occurring within the shops 102 associated with the customers using the wireless devices 110 (hereinafter referred to as sales volume), and
(b) increase in sales volume associated with one or more marketing campaigns being provided at the shops 102 and/or the hallway 104.
The predefined commercial parameters may be either system-defined or user-defined. The predefined commercial parameters may be determined for each shop separately, for a group of shops located in proximity to each other, or for the retailing premises 100 as a whole. The predefined commercial parameters may be determined periodically, or for a predefined period. The predefined commercial parameters may be determined for a single customer or a group of customers. The predefined commercial parameters may also be determined for certain demographics based on gender, income level, shopping history, and so on.

The data processing arrangement 202 may, for example, determine the sales volume as a function of the routes 112 taken by the wireless devices 110 as a function of time. In accordance with an embodiment of the present disclosure, the data processing arrangement 202 determines the sales volume in real time.

In addition, the data processing arrangement 202 stores data pertaining to the predefined commercial parameters in the commercial databases 208. Such data may, for example, be stored as a function of time.

In accordance with an additional embodiment of the present disclosure, the data processing arrangement 202 determines theft of items at the shops 102 and/or the retailing premises 100 as a function of the routes 112 taken by the wireless devices 110 as a function of time. For this purpose, the monitoring system 200 includes one or more cameras installed at suitable positions within the retailing premises 100. The data processing arrangement 202 may then employ the cameras to track the customers within the retailing premises 100, for use in the analysis of theft, for example as aforementioned.

In accordance with an embodiment of the present disclosure, the data processing arrangement 202 analyzes the predefined position parameters and/or the predefined commercial parameters, to identify fluctuations in at least one of: sales volume, GSH, customer volumes, customer dwell-times, and visiting frequencies. Based on these fluctuations, the data processing arrangement 202 may determine the rents and/or rates for the shops 102 within the retailing premises 100. Additionally, the data processing arrangement 202 may determine the impact of one or more marketing campaigns conducted in the retailing premises 100 on the predefined position parameters and/or the predefined commercial parameters. Accordingly, the data processing arrangement 202 may allocate costs of the marketing campaigns to the shops 102 within the retailing premises 100.

Based on the fluctuations, the data processing arrangement 202 also determines trends and patterns in the behavior of the customers using the wireless devices 110. The data processing arrangement 202 then creates a mathematical model describing the movement of the wireless devices 110 within the retailing premises 100, and applies a learning system on the mathematical model to generate a function describing trends occurring in the retailing premises 100.

Subsequently, the data processing arrangement 202 makes a prediction of future sales and/or GSH within the retailing premises 100 in relation to the marketing campaigns.

In accordance with an embodiment of the present disclosure, the data processing arrangement 202 is operable to apply neural network algorithms and/or fuzzy logic for executing the analyses. In accordance with an embodiment of the present disclosure, the data processing arrangement 202 executes the analyses in real time.

FIG. 2 is merely an example, which should not unduly limit the scope of the claims herein. One of ordinary skill in the art would recognize many variations, alternatives, and modifications of embodiments herein.

FIG. 3 is an illustration of various components III one exemplary implementation of the data processing arrangement 202, in accordance with the present disclosure. The data processing arrangement 202 includes, but is not limited to, a memory 302, a processor 304, Input/Output (I/O) devices 306, and a system bus 308 that operatively couples various components including memory 302 and processor 304. Memory 302 stores a position data module 310, a commercial data module 312 and a learning system module 314.

When executed on processor 304, the position data module 310 communicates with the wireless apparatus 108 to determine spatial data pertaining to the wireless devices 110. For example, the spatial data pertaining to the wireless devices 110 may include IDs associated with the wireless devices 110, spatial positions of the wireless devices 110, and associated time stamps.

The spatial positions pertaining to the wireless devices 110 may be determined, for example, by way of triangulation. The spatial positions may be determined using alternative arrangements, as described earlier.

The position data module 310 then analyzes the spatial data pertaining to the wireless devices 110, to record the routes 112 of the wireless devices 110 within the retailing premises 100. In accordance with an embodiment of the present disclosure, the routes 112 are recorded as a function of time. Data pertaining to the routes 112 is then stored in the position database 206.

Subsequently, the position data module 310 analyzes the routes 112 of the wireless devices 110, to determine the predefined position parameters as a function of time. As described earlier, the predefined position parameters include at least one of: customer volumes, customer dwell-times, GSH, and visiting frequencies. The position data module 310 then stores data pertaining to the predefined position parameters in the position database 206.

As described earlier, the predefined position parameters act as an indicator of retail performance and sales. For example, the GSH can be used to approximately predict sales volume in real time.

When executed on processor 304, the commercial data module 312 receives commercial data pertaining to transactions occurring within the shops 102. For example, the commercial data module 312 may communicate with Point-Of-Sales (POS) terminals of the shops 102, to receive the commercial data. Alternatively, the commercial data may be stored in the commercial databases 208 by the POS terminals of the shops 102. In such a case, the commercial data module 312 may communicate with the commercial databases 208, to receive the commercial data.

The commercial data may be received either in real time or periodically. The commercial data is indicative of the spatial positions of the wireless devices 110, such as shops in which commercial transactions have been performed by the customers using the wireless devices 110, and/or shops in which marketing campaigns have been conducted.

The commercial data includes at least one of: shop identification, boutique identification, marketing campaign identification, discount campaign identification, and associated time stamps. For example, the marketing campaign identification may pertain to marketing campaigns related to a particular shop, a group of shops, or the retailing premises 100. Additionally, the commercial data may also pertain to information about products and brands sold in the shops 102.

The commercial data module 312 then analyzes data pertaining to the routes 112 and the commercial data, to determine the predefined commercial parameters as a function of time. As described earlier, the predefined commercial parameters include at least one of: sales volume, and increase in sales volume associated with one or more marketing campaigns.

The commercial data module 312 may, for example, determine the sales volume as a function of the routes 112 taken by the wireless devices 110 as a function of time. In accordance with an embodiment of the present disclosure, the commercial data module 312 determines the sales volume in real time.

In addition, the commercial data module 312 stores data pertaining to the predefined commercial parameters in the commercial databases 208. Such data may, for example, be stored as a function of time.

In accordance with an additional embodiment of the present disclosure, the commercial data module 312 determines theft of items at the shops 102 and/or the retailing premises 100 as a function of the routes 112 taken by the wireless devices 110 as a function of time. For this purpose, the commercial data module 312 employs the cameras, to track the customers within the retailing premises 100, for use in the analysis of theft.

When executed on processor 304, the learning system module 314 analyzes current and historical values of the predefined position parameters and/or the predefined commercial parameters, to identify fluctuations in at least one of: sales volume, GSH, customer volumes, customer dwell-times, and visiting frequencies.

Based on these fluctuations, the learning system module 314 may determine the rents and/or rates for the shops 102 within the retailing premises 100. Additionally, the learning system module 314 may determine the impact of the marketing campaigns on the predefined position parameters and/or the predefined commercial parameters. Accordingly, the learning system module 314 may allocate costs of the marketing campaigns to the shops 102 within the retailing premises 100.

Based on the fluctuations, the learning system module 314 then determines trends and patterns in at least one of: sales volume, GSH, customer volumes, customer dwell-times and visiting frequencies. These trends and patterns provide information about the behavior of the customers using the wireless devices 110.

The learning system module 314 then creates a mathematical model describing the movement of the customers using the wireless devices 110 within the retailing premises 100, and applies a learning system on the mathematical model to generate a function describing trends occurring in the retailing premises 100. For this purpose, the learning system module 314 may use various statistical modeling algorithms.

Subsequently, the learning system module 314 uses the function to make a prediction of future sales and/or GSH within the retailing premises 100. Such a prediction may, for example, be made in relation to the marketing campaigns. In accordance with an embodiment of the present disclosure, the learning system module 314 makes a prediction on future sales and/or GSH in real time.

Moreover, the learning system module 314 may iteratively adjust the mathematical model to refine predictions on future sales and/or GSH. For this purpose, the learning system module 314 may compare actual and predicted values of sales volume, either in real time or periodically.

In accordance with an embodiment of the present disclosure, the learning system module 314 is operable to apply neural network algorithms and/or fuzzy logic for executing the analyses described above. In accordance with an embodiment of the present disclosure, the learning system module 314 executes the analyses in real time.

Let us consider an example to illustrate how the learning system module 314 executes the above analyses. In order to influence sales, owners of the shops 102 and/or the retailing premises 100 conduct various activities during a particular period.

The learning system module 314 may categorize these activities into one or more categories. Examples of possible categories could be:
(1) Marketing:
(a) Marketing campaigns within shops
(b) Other marketing campaigns
(2) Discount offering
(3) Retail changes:
(a) Introduction of new shops
(b) Refurbishment of existing shops
(c) Changes in window display of existing shops

The learning system module 314 may then benchmark each activity against the fluctuations in GSH. For example, sub-category “marketing campaign within shops” may be benchmarked as follows:
Number of marketing campaigns conducted during that period=5
Fluctuations in GSH measured for first marketing campaign=+5%

Fluctuations in GSH measured for second marketing campaign=+2%

Fluctuations in GSH measured for third marketing campaign=+3%

Fluctuations in GSH measured for fourth marketing campaign=+4%

Fluctuations in GSH measured for fifth marketing campaign=+5%

Total fluctuations in GSH=+19%

Average fluctuations in GSH=total fluctuations III GSH/number of marketing campaigns=+(19/5) %=3.8%

As a result, the learning system module 314 may predict that a marketing campaign conducted within a shop increases GSH by 3.8% on an average. Increase in GSH for a shop implies an increase in customer dwell-times and/or customer volumes in the shop, which in tum, implies increase in actual sales of the shop. In this manner, GSH acts as an indicator of retail performance and sales.

In addition, the learning system module 314 may also suggest changes for future marketing campaigns, such as a particular time of day and/or a particular day of week when the marketing campaigns are expected to have a greater impact, or a particular zone within the retailing premises 100 where the marketing campaigns are expected to have a greater impact. Such suggestions may, for example, be based on the GSH.

FIG. 3 is merely an example, which should not unduly limit the scope of the claims herein. It is to be understood that the specific designation for the data processing arrangement 202 is for the convenience of reader and is not to be construed as limiting the data processing arrangement 202 to specific numbers, types, or arrangements of modules and/or components of the data processing arrangement 202. One of ordinary skill in the art would recognize many variations, alternatives, and modifications of embodiments of the present disclosure.

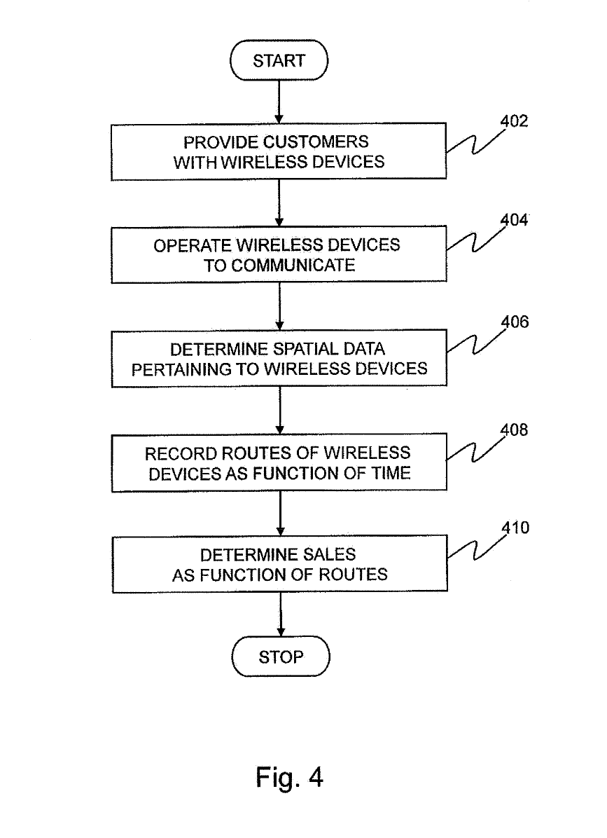

FIG. 4 is an illustration of steps of a method of using the monitoring system 200 for monitoring the customers within the retailing premises 100, in accordance with the present disclosure. The method is depicted as a collection of steps in a logical flow diagram, which represents a sequence of steps that can be implemented in hardware, software, or a combination thereof.

At a step 402, the customers are provided with their corresponding wireless devices 110. The wireless devices 110 are provided with associated IDs, which may, for example, be MAC addresses, TIDs, SSIDs, or other identification pertaining to the wireless devices 110. Optionally, the customers are encouraged to use the wireless devices 110 against a discount against purchase prices of products bought at the retailing premises.

At a step 404, the wireless devices 110 operate to communicate with the wireless communication network 204. The step 404 may, for example, include a sub-step in which the wireless devices 110 are implemented as smart telephones provided with a suitable hardware and/or software application that enables the wireless devices 110 to communicate via the wireless communication network 204 with the data processing arrangement 202.

Subsequently, at a step 406, the data processing arrangement 202 determines spatial data pertaining to the wireless devices 110. The spatial data pertaining to the wireless devices 110 may, for example, include their associated IDs, spatial positions of the wireless device 110, and associated time stamps. The data processing arrangement 202 may perform the step 406 by way of triangulation, or by using other alternative arrangements, as described earlier.

Thereafter, at a step 408, the data processing arrangement 202 analyzes the spatial data pertaining to the wireless devices 110, to record the routes 112 of the wireless devices 110 within the retailing premises 100. In accordance with an embodiment of the present disclosure, the routes 112 are recorded as a function of time.

Finally, at a step 410, the data processing arrangement 202 analyzes the routes 112 taken by the customers, to determine sales at the shops 102 and/or the retailing premises 100 as a function of the routes 112. In accordance with an embodiment of the present disclosure, the data processing arrangement 202 performs the step 410 in real time.

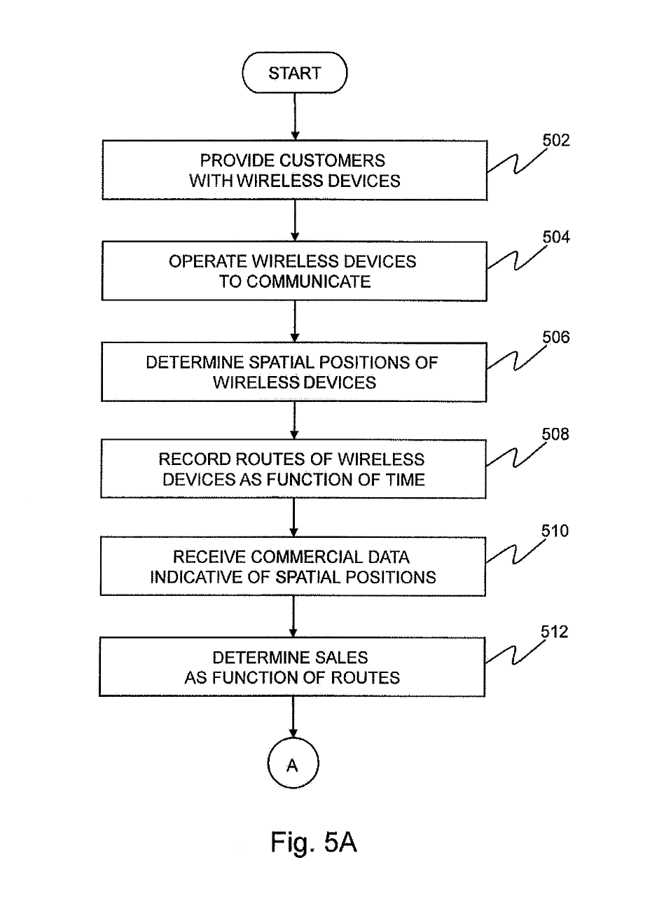

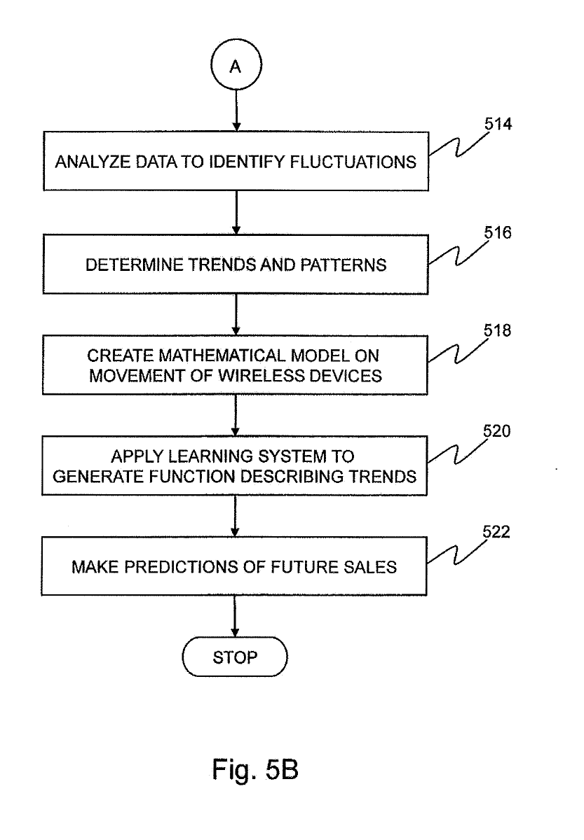

A more detailed example of executing the analyses (performed in the steps 408 and 410) is described below in more detail with reference to FIGS. 5A and 5B.

It should be noted here that the steps 402 to 410 are only illustrative and other alternatives can also be provided where one or more steps are added, one or more steps are removed, or one or more steps are provided in a different sequence without departing from the scope of the claims herein. For example, the data processing arrangement 202 may perform an additional step of determining theft of items at the shops 102 and/or the retailing premises 100 as a function of the routes 112.

FIG. 5 is an illustration of steps of a detailed method of using the monitoring system 200 for monitoring the customers within the retailing premises 100, in accordance with the present disclosure. The method is depicted as a collection of steps in a logical flow diagram, which represents a sequence of steps that can be implemented in hardware, software, or a combination thereof.

At a step 502, the customers are provided with their corresponding wireless devices 110. The wireless devices 110 are provided with associated IDs, which may, for example, be MAC addresses, TIDs, SSIDs, or other identification pertaining to the wireless devices 110.

At a step 504, the wireless devices 110 operate to communicate with the wireless communication network 204. The step 504 may, for example, include a sub-step in which the wireless devices 110 are implemented as smart telephones provided with a suitable hardware and/or software application that enables the wireless devices 110 to communicate via the wireless communication network 204 with the data processing arrangement 202.

In accordance with the step 504, the wireless devices 110 may, for example, transmit their identification codes (ID) to the wireless apparatus 108 on their own. Alternatively, the wireless apparatus 108 may send a request for identification to the wireless devices 110, which may then transmit their ID to the wireless apparatus 108.

Next, at a step 506, the position data module 310 within the data processing arrangement 202 determines spatial data pertaining to the wireless devices 110. The spatial data pertaining to the wireless devices 110 may, for example, include their associated IDs, spatial positions of the wireless devices 110, and associated time stamps.

The step 506 may, for example, include a sub-step in which the position data module 310 determines the spatial positions of the wireless devices 110. In one example, the spatial positions of the wireless devices 110 may be determined by way of triangulation. Alternatively, a spatial position of a particular wireless device may be determined as the location of a wireless apparatus in proximity to that wireless device. In yet another alternative, the wireless devices 110 may be configured to provide their spatial positions along with their ID to the wireless apparatus 108 on their own. For this purpose, the wireless devices 110 may be provided with one or more maps of the retailing premises 100.

Subsequently, at a step 508, the position data module 310 analyzes the spatial data pertaining to the wireless devices 110, to record the routes 112 of the wireless devices 110 as a function of time. The position data module 310 then analyzes the routes 112 of the wireless devices 110, to determine the predefined position parameters as a function of time. As described earlier, the predefined position parameters include at least one of: customer volumes, customer dwell-times, GSH, and visiting frequencies. In addition, the position data module 310 may store data pertaining to the predefined position parameters in the position database 206.

At a step 510, the commercial data module 312 within the data processing arrangement 202 receives commercial data pertaining to transactions occurring within the shops 102. The commercial data module 312 may perform the step 510 either in real time or periodically. The commercial data is indicative of the spatial positions of the wireless devices 110, such as shops in which commercial transactions have been performed by the customers using the wireless devices 110, and/or shops in which marketing campaigns have been conducted.

The commercial data includes at least one of: shop identification, boutique identification, marketing campaign identification, discount campaign identification, and associated time stamps. For example, the marketing campaign identification may pertain to marketing campaigns related to a particular shop, a group of shops, or the retailing premises 100. Additionally, the commercial data may also pertain to information about products and brands sold in the shops 102.

Subsequently, at a step 512, the commercial data module 312 analyzes data pertaining to the routes 112 and the commercial data, to determine the predefined commercial parameters as a function of time. As described earlier, the predefined commercial parameters include at least one of: sales volume, and increase in sales volume associated with one or more marketing campaigns. In accordance with an embodiment of the present disclosure, the commercial data module 312 determines sales at the shops 102 and/or the retailing premises 100 as a function of the routes 112. In addition, the commercial data module 312 may store data pertaining to the predefined commercial parameters in the commercial databases 208.

At a step 514, the learning system module 314 within the data processing arrangement 202 analyzes current and historical values of the predefined position parameters and/or the predefined commercial parameters, to identify fluctuations in at least one of: sales volume, GSH, customer volumes, customer dwell-times, and visiting frequencies.

Thereafter, at a step 516, the learning system module 314 determines trends and patterns in at least one of: sales volume, GSH, customer volumes, customer dwell-times and visiting frequencies. These trends and patterns provide information about the behavior of the customers using the wireless devices 110.

Next, at a step 518, the learning system module 314 creates a mathematical model describing the movement of the customers using the wireless devices 110 within the retailing premises 100.

Subsequently, at a step 520, the learning system module 314 applies a learning system on the mathematical model to generate a function describing trends occurring in the retailing premises 100. For this purpose, the learning system module 314 may use various statistical modeling algorithms.

Further, at a step 522, the learning system module 314 uses the function to make a prediction of future sales and/or GSH within the retailing premises 100. Such a prediction may, for example, be made in relation to the marketing campaigns.

Moreover, the learning system module 314 may perform additional steps to iteratively adjust the mathematical model to refine predictions on future sales and/or GSH. For this purpose, the learning system module 314 may compare actual and predicted values of sales volume, either in real time or periodically.

In accordance with an embodiment of the present disclosure, the learning system module 314 applies neural network algorithms and/or fuzzy logic for executing the analyses described in the steps 518 to 522. In accordance with an embodiment of the present disclosure, the learning system module 314 performs the steps 514 to 522 in real time.

It should be noted here that the steps 502 to 522 are only illustrative and other alternatives can also be provided where one or more steps are added, one or more steps are removed, or one or more steps are provided in a different sequence without departing from the scope of the claims herein. For example, the step 508 and the step 510 may be performed simultaneously.

Embodiments of the present disclosure can be used for various purposes, including, though not limited to, enabling owners of retailing premises to understand fluctuations in sales in real time by using GSH as an indicator, to predict impact of various campaigns and other efforts without a need for complicated integration of real-time commercial transactions, or to achieve higher return on investment (ROI) by suggesting changes in future marketing campaigns.

Although embodiments of the current invention have been described comprehensively, in considerable detail to cover the possible aspects, those skilled in the art would recognize that other versions of the invention are also possible.

What is claimed is:

1. A monitoring system for monitoring one or more customers within a retailing premises, wherein the system includes a data processing arrangement; and a wireless communication network coupled in communication with the data processing arrangement, wherein the one or more customers are provided with one or more corresponding wireless devices, each wireless device being provided with an associated identification code (ID), which are operable to communicate with the wireless communication network for enabling the data processing arrangement to monitor and record one or more routes of the one or more wireless devices within the retailing premises.

2. A monitoring system as claimed in claim 1, wherein the one or more wireless devices are implemented as one or more smart telephones provided with a software application that enables the one or more wireless devices to communicate via the wireless communication network with the data processing arrangement.

3. A monitoring system as claimed in claim 1, wherein the wireless communication network is employed to determine spatial data pertaining to the one or more wireless devices by way of triangulation.

4. A monitoring system as claimed in claim 1, wherein the data processing arrangement is operable to record the one or more routes of the one or more wireless devices as a function of time.

5. A monitoring system as claimed in claim 1, wherein one or more entrances and/or exit doors of the retailing premises are equipped with wireless apparatus in communication with the data processing arrangement, for detecting when the one or more customers enter and/or exit the retailing premises.

6. A monitoring system as claimed in claim 1, wherein the system includes one or more databases, and wherein the data processing arrangement is operable to analyze data stored in the one or more databases for determining sales at the retailing premises as a function of routes taken by the one or more wireless devices as a function of time.

7. A monitoring system as claimed in claim 6, wherein the data processing arrangement is operable to determine sales at the retailing premises in real time.

8. A monitoring system as claimed in claim 1, wherein the system includes one or more databases, and wherein the data processing arrangement is operable to analyze data stored in the one or more databases for determining theft of items at the retailing premises as a function of routes taken by the one or more wireless devices as a function of time.

9. A monitoring system as claimed in claim 8, wherein the system includes one or more cameras for tracking the customers within the retailing premises for use in the analysis of theft executed in the data processing arrangement.

10. A monitoring system as claimed in claim 1, wherein the retailing premises are partitioned into a plurality of zones, and wherein rents and/or rates for the zones are determined from at least one of: a number of the one or more wireless devices having routes traversing the zones, one or more dwell times of the one or more wireless devices within the zones, Gross Shopping Hours (GSH) spent by the one or more wireless devices within the zones, a visiting frequency of the one or more wireless devices within the zones, sales occurring within the zones associated with the one or more customers using the one or more wireless devices, and increase in sales occurring within the zones associated with one or more marketing campaigns being provided at the zones.

11. A monitoring system as claimed in claim 1, wherein at least one of:
(a) the data processing arrangement IS operable to determine spatial data pertaining to the one or more wireless devices, wherein the spatial data includes one or more identification codes (ID) associated with the one or more wireless devices, one or more spatial positions of the one or more wireless devices within the retailing premises, and associated time stamps;
(b) the data processing arrangement is operable to receive commercial data indicative of the one or more spatial positions, wherein the commercial data includes at least one of: shop identification, boutique identification, marketing campaign identification, discount campaign identification, and associated time stamps;
(c) the data processing arrangement is operable to analyze data received in (a) and (b) to identify fluctuations in at least one of: sales volume, gross shopping hours (GSH), customer volumes, customer dwell-times, and visiting frequencies;
(d) the data processing arrangement is operable to analyze data received in (a) to (c) to determine trends and patterns in data related to the one or more wireless devices;
(e) the data processing arrangement is operable from (d) to create a mathematical model describing movement of the one or more wireless devices within the retailing premises;
(f) the data processing arrangement is operable from (e) to apply a learning system on the mathematical model to generate a function describing trends occurring in the retailing premises; and
(g) the data processing arrangement is operable from (f) to make a prediction of future sales and/or GSH within the retailing premises in relation to one or more marketing campaigns.

12. A monitoring system as claimed in claim 11, wherein the data processing arrangement is operable to apply neural network algorithms and/or fuzzy logic for executing the analyses.

13. A method of using a monitoring system for monitoring one or more customers within a retailing premises, wherein the monitoring system includes a data processing arrangement and a wireless communication network coupled in communication with the data processing arrangement, wherein the method includes:
(a) providing the one or more customers with one or more corresponding wireless devices, each wireless device being provided with an associated identification code (ID); and
(b) operating the one or more wireless devices to communicate with the wireless communication network for enabling the data processing arrangement to monitor and record one or more routes of the one or more wireless devices within the retailing premises.

14. A method as claimed in claim 13, wherein the method includes implementing the one or more wireless devices as one or more smart telephones provided with a software application that enables the one or more wireless devices to communicate via the wireless communication network with the data processing arrangement.

15. A method as claimed in claim 13, wherein the method includes employing the wireless communication network to determine spatial data pertaining to the one or more wireless devices by way of triangulation.

16. A method as claimed in claim 13, wherein the method includes using the data processing arrangement to record the one or more routes of the one or more wireless devices as a function of time.

17. A method as claimed in claim 13, wherein the method includes equipping one or more entrances and/or exit doors of the retailing premises with wireless apparatus in communication with the data processing arrangement, for detecting when the one or more customers enter and/or exit the retailing premises.

18. A method as claimed in claim 13, wherein the method includes providing the system with one or more databases; and using the data processing arrangement to analyze data stored in the one or more databases for determining sales at the retailing premises as a function of routes taken by the one or more wireless devices as a function of time.

19. A method as claimed in claim 18, wherein the method includes using the data processing arrangement to determine sales at the retailing premises in real time.

20. A method as claimed in claim 13, wherein the method includes providing the system with one or more databases; and using the data processing arrangement to analyze data stored in the one or more databases for determining theft of items at the retailing premises as a function of routes taken by the one or more wireless devices as a function of time.

21. A method as claimed in claim 20, wherein the method includes providing the system with one or more cameras; and using the one or more cameras to track the customers within the retailing premises for use in the analysis of theft executed in the data processing arrangement.

22. A method as claimed in claim 13, wherein the method includes partitioning the retailing premises into a plurality of zones; and determining rents and/or rates for the zones from at least one of: a number of the one or more wireless devices having routes traversing the zones, one or more dwell times of the one or more wireless devices within the zones, Gross Shopping Hours (GSH) spent by the one or more wireless devices within the zones, a visiting frequency of the one or more wireless devices within the zones, sales occurring within the zones associated with the one or more customers using the one or more wireless devices, and increase in sales occurring within the zones associated with one or more marketing campaigns being provided at the zones.

23. A method as claimed in claim 13, wherein at least one of:
(a) the data processing arrangement is operable to determine spatial data pertaining to the one or more wireless devices, wherein the spatial data includes one or more identification codes (ID) associated with the one or more wireless devices, one or more spatial positions of the one or more wireless devices within the retailing premises, and associated time stamps;
(b) the data processing arrangement is operable to receive commercial data indicative of the one or more spatial positions, wherein the commercial data includes at least one of: shop identification, boutique identification, marketing campaign identification, discount campaign identification, and associated time stamps;
(c) the data processing arrangement is operable to analyze data received in (a) and (b) to identify fluctuations in at least one of: sales volume, gross shopping hours (GSH), customer volumes, customer dwell-times, and visiting frequencies;
(d) the data processing arrangement is operable to analyze data received in (a) to (c) to determine trends and patterns in data related to the one or more wireless devices;
(e) the data processing arrangement is operable from (d) to create a mathematical model describing movement of the one or more wireless devices within the retailing premises;
(f) the data processing arrangement is operable from (e) to apply a learning system on the mathematical model to generate a function describing trends occurring in the retailing premises; and
(g) the data processing arrangement is operable from (f) to make a prediction of future sales and/or GSH within the retailing premises in relation to one or more marketing campaigns.

24. A method as claimed in claim 23, wherein the method includes applying neural network algorithms and/or fuzzy logic for executing the analyses.

25. A software product recorded on machine-readable data storage media, wherein the software product is executable upon computing hardware for executing a method as claimed in claim 13.

26. A software product as claimed in claim 25, wherein the software product is downloadable as a software application onto one or more wireless devices.
